(19) United States
(12) Patent Application Publication
(10) Pub. No.: US 2013/0222816 A1
(43) Pub. Date: Aug. 29, 2013

(54) COORDINATE MEASURING MACHINE HAVING AN ILLUMINATED PROBE END AND METHOD OF OPERATION

(71) Applicant: FARO TECHNOLOGIES, INC., (US)

(72) Inventors: Clark H. Briggs, DeLand, FL (US); David Danielson, Sorrento, FL (US)

(73) Assignee: FARO TECHNOLOGIES, INC., Lake Mary, FL (US)

(21) Appl. No.: 13/803,571

(22) Filed: Mar. 14, 2013

Related U.S. Application Data
(63) Continuation-in-part of application No. 13/632,253, filed on Oct. 1, 2012.
Application No. 13/632,253 is a continuation of application No. 13/006,471, filed on Jan. 14, 2011, now Pat. No. 8,284,407.
Application No. 13/006,471 is a continuation-in-part of application No. 13/006,507, filed on Jan. 14, 2011.
(60) Provisional application No. 61/296,555, filed on Jan. 20, 2010.
(60) Provisional application No. 61/362,497, filed on Jul. 8, 2010.
(60) Provisional application No. 61/296,555, filed on Jan. 20, 2010.
(60) Provisional application No. 61/355,279, filed on Jun. 16, 2010.
(60) Provisional application No. 61/351,347, filed on Jun. 4, 2010.

(51) Int. Cl. G01B 11/00

(52) U.S. Cl. CPC G01B 11/005
USPC 356/614

(57) ABSTRACT

A method of conveying information with a portable articulated arm coordinate measuring machine (AACMM) is provided. The method includes the steps of providing a manually positionable articulated arm portion having opposed first and second ends, the arm portion including a plurality of connected arm segments with a measurement device coupled to the first end. A light source is coupled to the first end, the light source configured to emit a visible light pattern on a surface of an object. A first processor determines a location of a next measurement and a type of the next measurement to be performed by an operator, the type of the measurement selected from among a plurality of measurement types. The first processor determines the light pattern based at least in part on the type of the next measurement. The light pattern is projected proximal to the location.

### CROSS-REFERENCE TO RELATED APPLICATIONS

The present application is a continuation in part application of U.S. patent application Ser. No. 13/632,253 filed on Oct. 1, 2012, which is a continuation of U.S. patent application Ser. No. 13/006,471 filed on Jan. 14, 2011, which claims the benefit of Provisional Application Ser. No. 61/296,555 filed Jan. 20, 2010 and Provisional Application Ser. No. 61/362,497 filed Jul. 8, 2010, the contents of all of which are hereby incorporated by reference in their entirety. The present application is also a continuation in part application of U.S. patent application Ser. No. 13/006,507 filed on Jan. 14, 2011, which claims the benefit of Provisional Application Ser. No. 61/296,555 filed on Jan. 10, 2010, and also claims benefit of Provisional Application Ser. No. 61/355,279 filed on Jun. 16, 2010, and also claims further benefit of Provisional Application Ser. No. 61/351,347 filed on Jun. 4, 2010, the contents of all of which are hereby incorporated by reference in their entirety.

### BACKGROUND

The present disclosure relates to a coordinate measuring machine, and more particularly to a portable articulated arm coordinate measuring machine having targeted area illumination features integrated into the probe end of the portable coordinate measuring machine.

Portable articulated arm coordinate measuring machines (AACMMs) have found widespread use in the manufacturing or production of parts where there is a need to rapidly and accurately verify the dimensions of the part during various stages of the manufacturing or production (e.g., machining) of the part. Portable AACMMs represent a vast improvement over known stationary or fixed, cost-intensive and relatively difficult to use measurement installations, particularly in the amount of time it takes to perform dimensional measurements of relatively complex parts. Typically, a user of a portable AACMM simply guides a probe along the surface of the part or object to be measured. The measurement data are then recorded and provided to the user. In some cases, the data are provided to the user in visual form, for example, three-dimensional (3-D) form on a computer screen. In other cases, the data are provided to the user in numeric form, for example when measuring the diameter of a hole, the text “Diameter=1.0034” is displayed on a computer screen.

An example of a prior art AACMM is disclosed in commonly assigned U.S. Pat. No. 5,402,582 ('582), which is incorporated herein by reference in its entirety. The '582 patent discloses a 3-D measuring system comprised of a manually-operated AACMM having a support base on one end and a measurement probe at the other end. Commonly assigned U.S. Pat. No. 5,611,147 ('147), which is incorporated herein by reference in its entirety, discloses a similar AACMM. In the '147 patent, the AACMM includes a number of features including an additional rotational axis at the probe end, thereby providing for an arm with either a two-two-two or a two-two-three axis configuration (the latter case being a seven axis arm).

When manipulating a probe at the end of an AACMM, it is often desirable for the operator of the AACMM to work or see within part of a cavity, underneath a lip on a part for example. These or other relatively difficult to access positions often result in the surface of the part being in a shadow. It should be appreciated that this positioning sometimes makes it relatively difficult for the operator of the AACMM to properly discern features of the part being accessed by the probe for measurement. Oftentimes supplemental illumination apart from the arm of the AACMM is provided in the form of portable work lights, head mounted lights, or a hand-held light. However, these can be cumbersome for the operator of the AACMM to use, and may require additional time or manpower to set up and operate.

While existing AACMM's are suitable for their intended purposes, what is needed is a portable AACMM that has certain features of embodiments of the present invention. In particular, what is needed is an effective solution for the illumination of relatively difficult to illuminate part locations through use of targeted area illumination.

### SUMMARY OF THE INVENTION

In accordance with one embodiment of the invention, a method of conveying information with a portable articulated arm coordinate measuring machine (AACMM) is provided. The steps includes providing a manually positionable articulated arm portion having opposed first and second ends, the arm portion including a plurality of connected arm segments, each of the arm segments including at least one position transducer for producing position signals. A measurement device is provided coupled to the first end. An electronic circuit is provided for receiving the position signals from the transducers and for determining a first position of the measurement device. A light source is provided coupled to the first end, the light source configured to emit a light pattern on a surface of an object, the light pattern being a pattern of visible light. A first processor is provided. A location of a next measurement and a type of the next measurement to be performed by an operator is determined with the first processor, the type of the next measurement selected from among a plurality of measurement types. The first processor determines the light pattern based at least in part on the type of the next measurement. The light pattern is projected proximal to the location.

According to another embodiment of the invention, a portable articulated arm coordinate measuring machine (AACMM) is provided. The AACMM includes a manually positionable articulated arm portion having opposed first and second ends, the arm portion including a plurality of connected arm segments, each of the arm segments including at least one position transducer for producing position signals. A measurement device is coupled to the first end. An electronic circuit is provided for receiving the position signals from the transducers and for determining a position of the measurement device. A light source is coupled to the first end, the light source configured to emit a light pattern on a surface of an object, the light pattern being a pattern of visible light. A first processor is configured to perform steps of: determining with the first processor a location of a next measurement and a type of the next measurement to be performed by an operator, the type of the next measurement selected from among a plurality of measurement types; determining with the first processor the light pattern based at least in part on the type of the next measurement; and projecting the light pattern proximal to the location.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1, including FIGS. 1A and 1B, are perspective views of a portable articulated arm coordinate measuring machine (AACMM) having embodiments of various aspects of the present invention therewithin;

FIG. 2, including FIGS. 2A-2D taken together, is a block diagram of electronics utilized as part of the AACMM of FIG. 1 in accordance with an embodiment;

FIG. 3, including FIGS. 3A and 3B taken together, is a block diagram describing detailed features of the electronic data processing system of FIG. 2 in accordance with an embodiment;

FIG. 4 is a more detailed perspective view of the probe end section of the AACMM of FIG. 1 having the handle and an illuminated probe attached thereto;

FIG. 5 is a cross sectional, cutaway view of the measurement device shown in FIG. 4 having integrated targeted area illumination features according to an embodiment of the present invention;

FIG. 6 is a perspective view of a light pipe originating from one or more light sources within the probe housing and being configured as a light ring to thereby provide 360 degrees of illumination around the probe housing near the measurement device;

FIG. 7 is an exploded view of another embodiment of the present invention in which the LEDs and the electronics boards are installed with the probe end at the end of the AACMM of FIG. 1;

FIG. 8 is a perspective view of the probe housing of the embodiment of FIG. 7 in which the probe housing has holes, light pipes or lenses through which the light from the LEDs on the probe end travels through lenses on the probe housing to a targeted area;

FIG. 9 is a perspective view of another embodiment of the present invention in which the probe end of the AACMM is illuminated by one or more light sources located on an electronics circuit board positioned inside the probe end of the AACMM;

FIG. 10 is a perspective view of a handle attached to the probe end of the AACMM of FIG. 1, wherein the handle includes one or more integrated light sources, according to another embodiment of the invention;

FIG. 11 is a perspective view of a laser line probe (LLP) mounted to the AACMM of FIG. 1 with an integrated light source located on the front of the LLP, according to another embodiment of the invention;

FIG. 12 is a side view of a probe end of the AACMM of FIG. 1 in which the probe end has a light ring capable of displaying different colors; and

FIG. 13-18 are perspective views of a portable articulated arm coordinate measuring machine (AACMM) having a light projector for communicating instructions to the operator.

### DETAILED DESCRIPTION

It is desirable to have a portable articulated arm coordinate measuring machine that provides illumination and visual feedback to the operator. Embodiments of the present invention include advantages of an integrated light source that directs light onto a measurement device and the surrounding area. Other embodiments of the present invention include advantages in providing a visual indication to the operator of the status of the coordinate measurement machine with a colored light source on a probe end. Still other embodiments of the invention include advantages of a light source coupled with a sensor to provide the operator with a visual feedback of a measured parameter associated with the measured object.

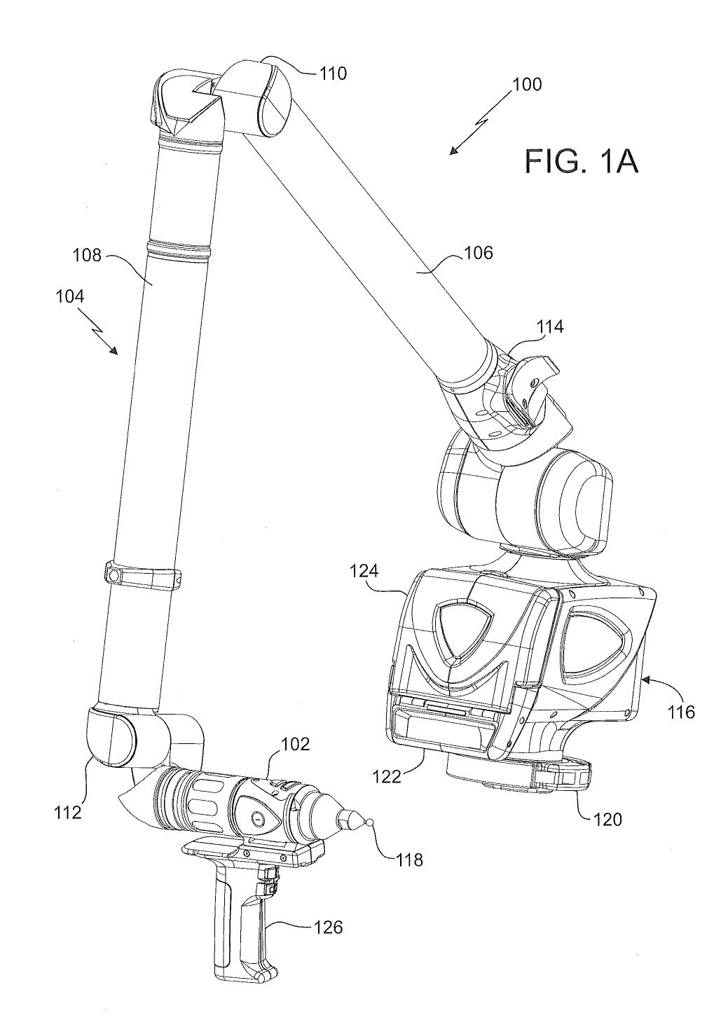

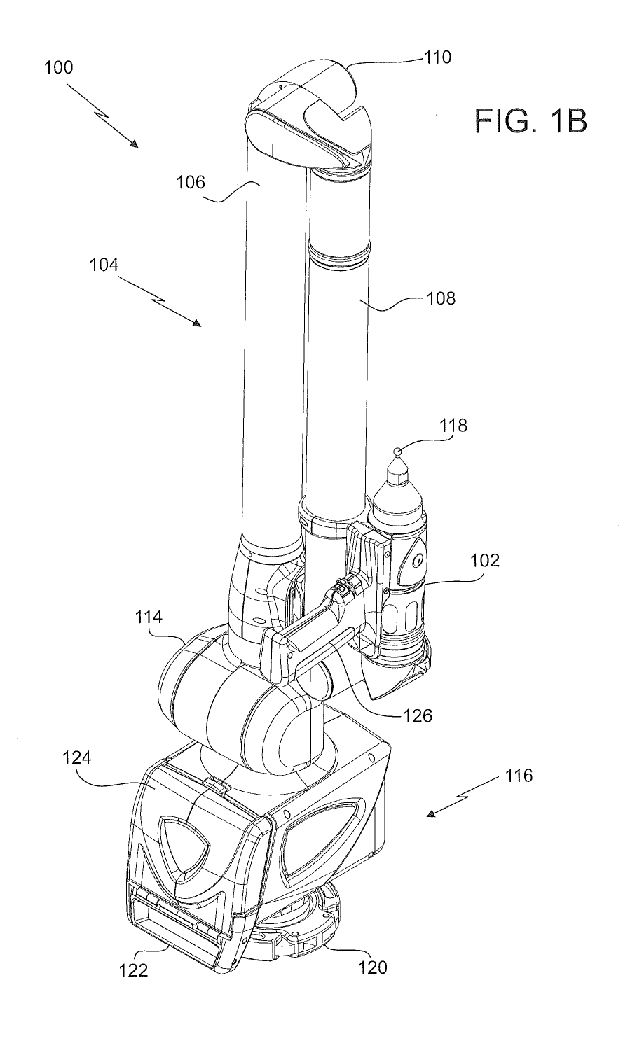

FIGS. 1A and 1B illustrate, in perspective, a portable articulated arm coordinate measuring machine (AACMM) 100 according to various embodiments of the present invention, an articulated arm being one type of coordinate measuring machine. As shown in FIGS. 1A and 1B, the exemplary AACMM 100 may comprise a six or seven axis articulated measurement device having a measurement probe housing 102 coupled to an arm portion 104 of the AACMM 100 at one end. The arm portion 104 comprises a first arm segment 106 coupled to a second arm segment 108 by a first grouping of bearing cartridges 110 (e.g., two bearing cartridges). A second grouping of bearing cartridges 112 (e.g., two bearing cartridges) couples the second arm segment 108 to the measurement probe housing 102. A third grouping of bearing cartridges 114 (e.g., three bearing cartridges) couples the first arm segment 106 to a base 116 located at the other end of the arm portion 104 of the AACMM 100. Each grouping of bearing cartridges 110, 112, 114 provides for multiple axes of articulated movement. Also, the measurement probe housing 102 may comprise the shaft of the seventh axis portion of the AACMM 100 (e.g., a cartridge containing an encoder system that determines movement of the measurement device, for example a probe 118, in the seventh axis of the AACMM 100). In use of the AACMM 100, the base 116 is typically affixed to a work surface.

Each bearing cartridge within each bearing cartridge grouping 110, 112, 114 typically contains an encoder system (e.g., an optical angular encoder system). The encoder system (i.e., transducer) provides an indication of the position of the respective arm segments 106, 108 and corresponding bearing cartridge groupings 110, 112, 114 that all together provide an indication of the position of the probe 118 with respect to the base 116 (and, thus, the position of the object being measured by the AACMM 100 in a certain frame of reference—for example a local or global frame of reference). The arm segments 106, 108 may be made from a suitably rigid material such as but not limited to a carbon composite material for example. A portable AACMM 100 with six or seven axes of articulated movement (i.e., degrees of freedom) provides advantages in allowing the operator to position the probe 118 in a desired location within a 360° area about the base 116 while providing an arm portion 104 that may be easily handled by the operator. However, it should be appreciated that the illustration of an arm portion 104 having two arm segments 106, 108 is for exemplary purposes, and the claimed invention should not be so limited. An AACMM 100 may have any number of arm segments coupled together by bearing cartridges (and, thus, more or less than six or seven axes of articulated movement or degrees of freedom).

The probe 118 is detachably mounted to the measurement probe housing 102, which is connected to bearing cartridge grouping 112. A handle 126 is removable with respect to the measurement probe housing 102 by way of, for example, a quick-connect interface. The handle 126 may be replaced with another device (e.g., a laser line probe, a bar code reader), thereby providing advantages in allowing the operator to use different measurement devices with the same AACMM 100. In exemplary embodiments, the probe housing 102 houses a removable probe 118, which is a contacting measurement device and may have different tips 118 that physically contact the object to be measured, including, but not limited to: ball, touch-sensitive, curved and extension type probes. In other embodiments, the measurement is performed, for example, by a non-contacting device such as a laser line probe (LLP). In an embodiment, the handle 126 is replaced with the LLP using the quick-connect interface. Other types of measurement devices may replace the removable handle 126 to provide additional functionality. Examples of such measurement devices include, but are not limited to, one or more illumination lights, a temperature sensor, a thermal scanner, a bar code scanner, a projector, a paint sprayer, a camera, or the like, for example.

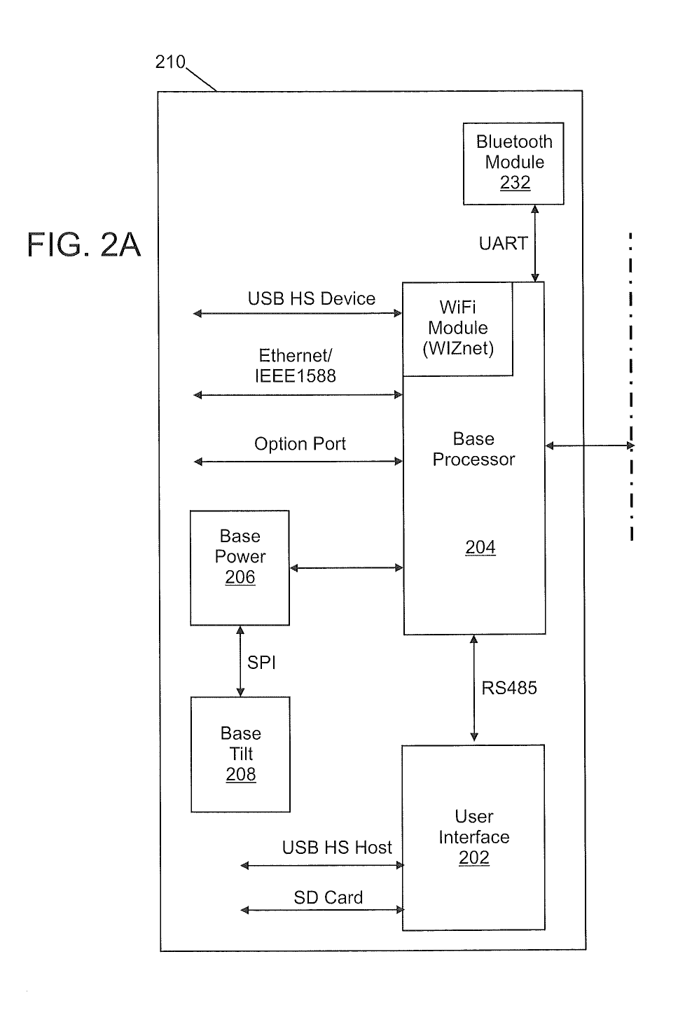

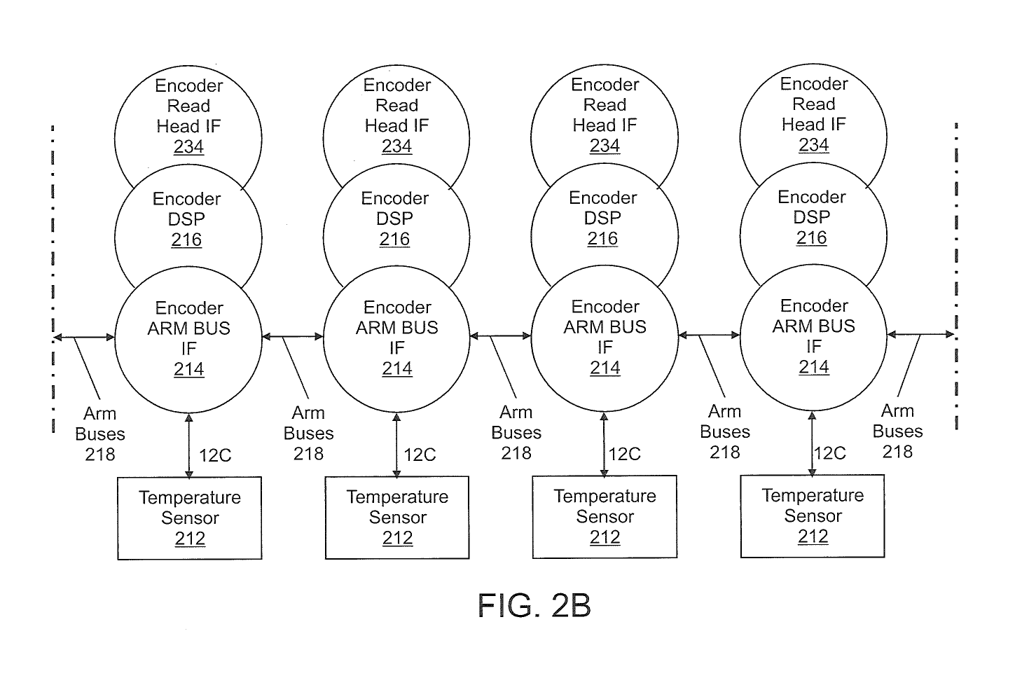

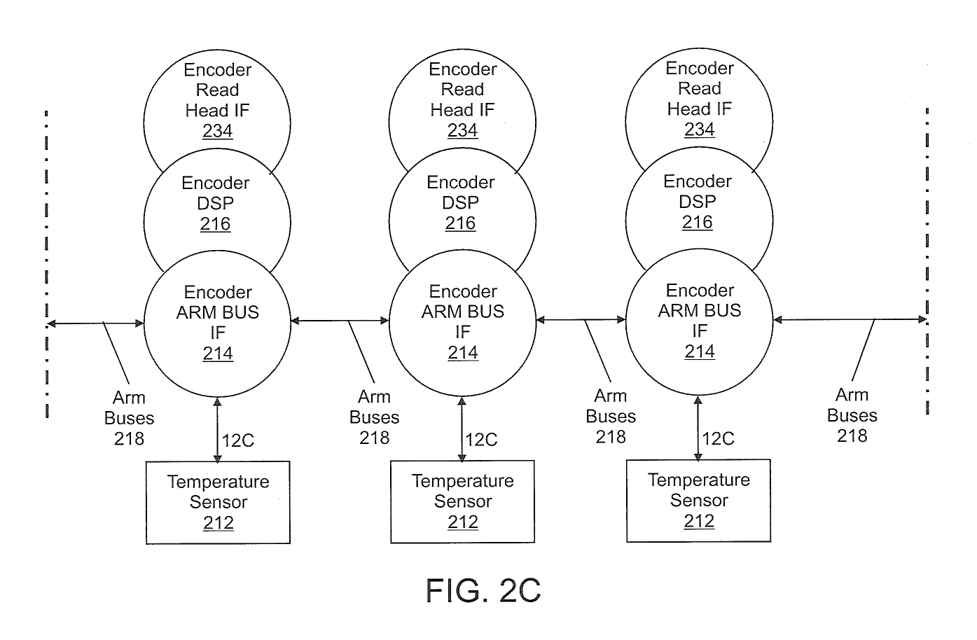

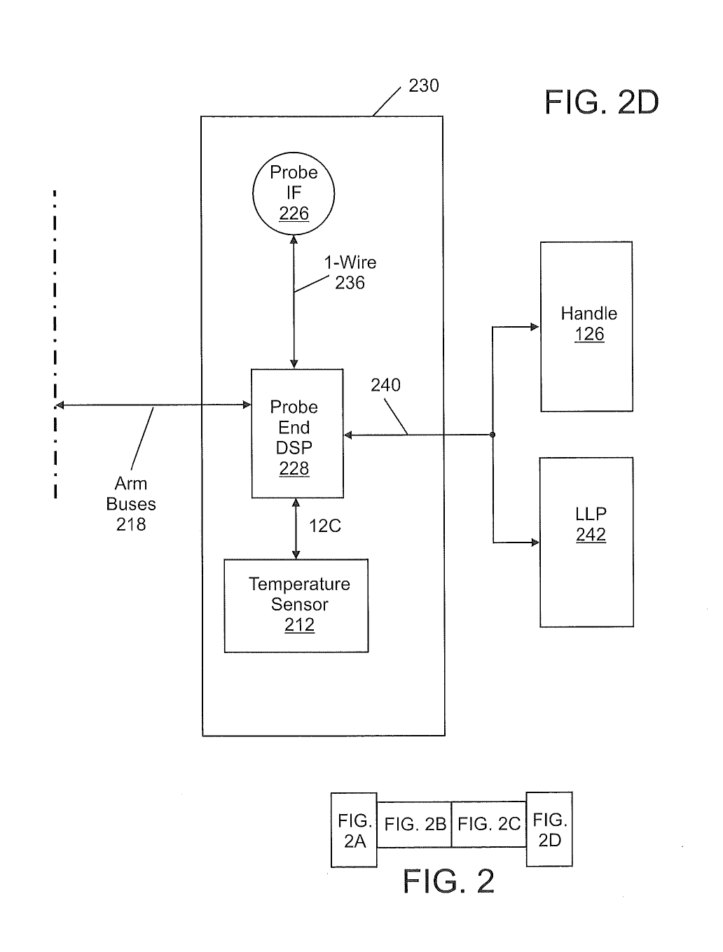

As shown in FIGS. 1A and 1B, the AACMM 100 includes the removable handle 126 that provides advantages in allowing accessories or functionality to be changed without removing the measurement probe housing 102 from the bearing cartridge grouping 112. As discussed in more detail below with respect to FIG. 2, the removable handle 126 may also include an electrical connector that allows electrical power and data to be exchanged with the handle 126 and the corresponding electronics located in the probe end.

In various embodiments, each grouping of bearing cartridges 110, 112, 114 allows the arm portion 104 of the AACMM 100 to move about multiple axes of rotation. As mentioned, each bearing cartridge grouping 110, 112, 114 includes corresponding encoder systems, such as optical angular encoders for example, that are each arranged coaxially with the corresponding axis of rotation of, e.g., the arm segments 106, 108. The optical encoder system detects rotational (swivel) or transverse (hinge) movement of, e.g., each one of the arm segments 106, 108 about the corresponding axis and transmits a signal to an electronic data processing system within the AACMM 100 as described in more detail herein below. Each individual raw encoder count is sent separately to the electronic data processing system as a signal where it is further processed into measurement data. No position calculator separate from the AACMM 100 itself (e.g., a serial box) is required, as disclosed in commonly assigned U.S. Pat. No. 5,402,582 (582).

The base 116 may include an attachment device or mounting device 120. The mounting device 120 allows the AACMM 100 to be removably mounted to a desired location, such as an inspection table, a machining center, a wall or the floor for example. In one embodiment, the base 116 includes a handle portion 122 that provides a convenient location for the operator to hold the base 116 as the AACMM 100 is being moved. In one embodiment, the base 116 further includes a movable cover portion 124 that folds down to reveal a user interface, such as a display screen.

In accordance with an embodiment, the base 116 of the portable AACMM 100 contains or houses an electronic data processing system that includes two primary components: a base processing system that processes the data from the various encoder systems within the AACMM 100 as well as data representing other arm parameters to support three-dimensional (3-D) positional calculations; and a user interface processing system that includes an on-board operating system, a touch screen display, and resident application software that allows for relatively complete metrology functions to be implemented within the AACMM 100 without the need for connection to an external computer.

The electronic data processing system in the base 116 may communicate with the encoder systems, sensors, and other peripheral hardware located away from the base 116 (e.g., a LLP, a light projector or other component that can be coupled to or integrated with the removable handle 126 on the AACMM 100). The electronics that support these peripheral hardware devices or features may be located in each of the bearing cartridge groupings 110, 112, 114 located within the portable AACMM 100.

FIG. 2 is a block diagram of an electronic circuit utilized in an AACMM 100 in accordance with an embodiment. The embodiment shown in FIG. 2 includes an electronic data processing system 210 including a base processor board 204 for implementing the base processing system, a user interface board 202, a base power board 206 for providing power, a Bluetooth module 232, and a base tilt board 208. The user interface board 202 includes a computer processor for executing application software to perform user interface, display, and other functions described herein.

As shown in FIG. 2, the electronic data processing system 210 is in communication with the aforementioned plurality of encoder systems via one or more arm buses 218. In the embodiment depicted in FIG. 2, each encoder system generates encoder data and includes: an encoder arm bus interface 214, an encoder digital signal processor (DSP) 216, an encoder read head interface 234, and a temperature sensor 212. Other devices, such as strain sensors, may be attached to the arm bus 218.

Also shown in FIG. 2 are probe end electronics 230 that are in communication with the arm bus 218. The probe end electronics 230 include a probe end DSP 228, a temperature sensor 212, a handle/LLP interface bus 240 that connects with the handle 126 or the LLP 242 via the quick-connect interface in an embodiment, and a probe interface 226. The quick-connect interface allows access by the handle 126 to the data bus, control lines, and power bus used by the LLP 242 and other accessories. In an embodiment, the probe end electronics 230 are located in the measurement probe housing 102 on the AACMM 100. In an embodiment, the handle 126 may be removed from the quick-connect interface and measurement may be performed by the laser line probe (LLP) 242 communicating with the probe end electronics 230 of the AACMM 100 via the handle/LLP interface bus 240. In an embodiment, the electronic data processing system 210 is located in the base 116 of the AACMM 100, the probe end electronics 230 are located in the measurement probe housing 102 of the AACMM 100, and the encoder systems are located in the bearing cartridge groupings 110, 112, 114. The probe interface 226 may connect with the probe end DSP 228 by any suitable communications protocol, including commercially-available products from Maxim Integrated Products, Inc. that embody the 1-wire® communications protocol 236.

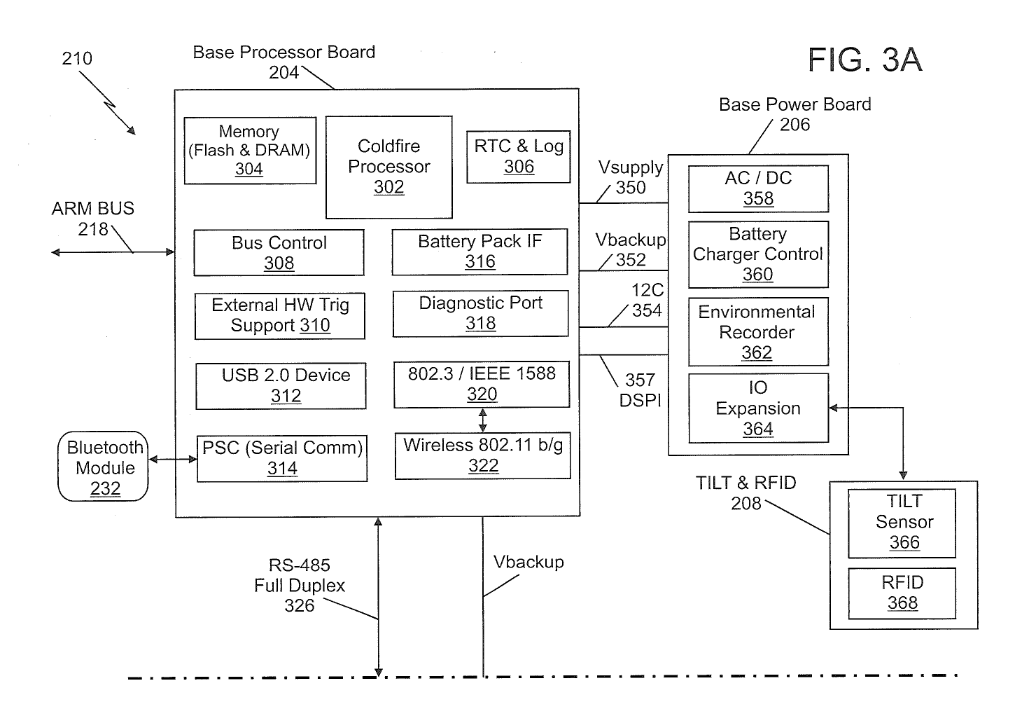

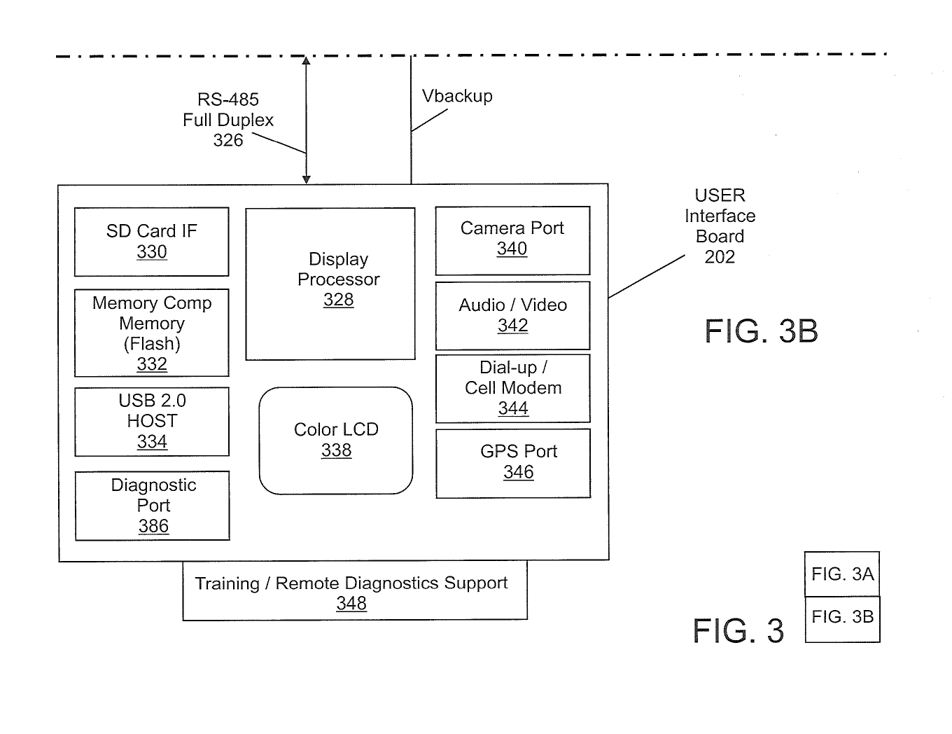

FIG. 3 is a block diagram describing detailed features of the electronic data processing system 210 of the AACMM 100 in accordance with an embodiment. In an embodiment, the electronic data processing system 210 is located in the base 116 of the AACMM 100 and includes the base processor board 204, the user interface board 202, a base power board 206, a Bluetooth module 232, and a base tilt module 208.

In an embodiment shown in FIG. 3, the base processor board 204 includes the various functional blocks illustrated therein. For example, a base processor function 302 is utilized to support the collection of measurement data from the AACMM 100 and receives raw arm data (e.g., encoder system data) via the arm bus 218 and a bus control module function 308. The memory function 304 stores programs and static arm configuration data. The base processor board 204 also includes an external hardware option port function 310 for communicating with any external hardware devices or accessories such as an LLP 242. A real time clock (RTC) and log 306, a battery pack interface (IF) 316, and a diagnostic port 318 are also included in the functionality in an embodiment of the base processor board 204 depicted in FIG. 3.

The base processor board 204 also manages all the wired and wireless data communication with external (host computer) and internal (display processor 328) devices. The base processor board 204 has the capability of communicating with an Ethernet network via an Ethernet function 320 (e.g., using a clock synchronization standard such as Institute of Electrical and Electronics Engineers (IEEE) 1588), with a wireless local area network (WLAN) via a LAN function 322, and with Bluetooth module 232 via a parallel to serial communications (PSC) function 314. The base processor board 204 also includes a connection to a universal serial bus (USB) device 312.

The base processor board 204 transmits and collects raw measurement data (e.g., encoder system counts, temperature readings) for processing into measurement data without the need for any preprocessing, such as disclosed in the serial box of the aforementioned '582 patent. The base processor 204 sends the processed data to the display processor 328 on the user interface board 202 via an RS485 interface (IF) 326. In an embodiment, the base processor 204 also sends the raw measurement data to an external computer.

Turning now to the user interface board 202 in FIG. 3, the angle and positional data received by the base processor is utilized by applications executing on the display processor 328 to provide an autonomous metrology system within the AACMM 100. Applications may be executed on the display processor 328 to support functions such as, but not limited to: measurement of features, guidance and training graphics, remote diagnostics, temperature corrections, control of various operational features, connection to various networks, and display of measured objects. Along with the display processor 328 and a liquid crystal display (LCD) 338 (e.g., a touch screen LCD) user interface, the user interface board 202 includes several interface options including a secure digital (SD) card interface 330, a memory 332, a USB Host interface 334, a diagnostic port 336, a camera port 340, an audio/video interface 342, a dial-up/ cell modem 344 and a global positioning system (GPS) port 346.

The electronic data processing system 210 shown in FIG. 3 also includes a base power board 206 with an environmental recorder 362 for recording environmental data. The base power board 206 also provides power to the electronic data processing system 210 using an AC/DC converter 358 and a battery charger control 360. The base power board 206 communicates with the base processor board 204 using inter-integrated circuit (I2C) serial single ended bus 354 as well as via a DMA serial peripheral interface (DSPI) 356. The base power board 206 is connected to a tilt sensor and radio frequency identification (RFID) module 208 via an input/output (I/O) expansion function 364 implemented in the base power board 206.

Though shown as separate components, in other embodiments all or a subset of the components may be physically located in different locations and/or functions combined in different manners than that shown in FIG. 3. For example, in one embodiment, the base processor board 204 and the user interface board 202 are combined into one physical board.

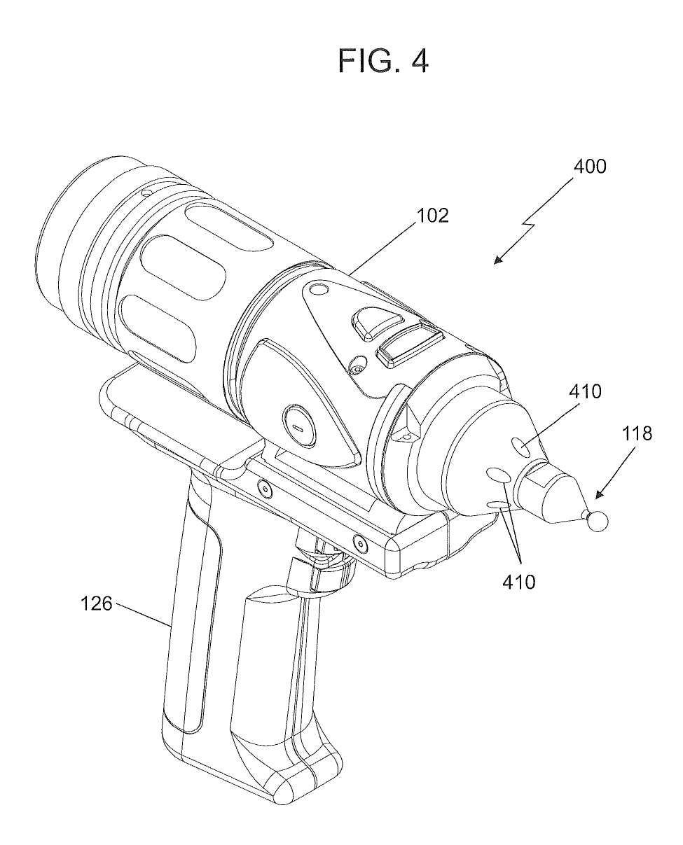

Referring to FIG. 4, there illustrated in more detail is the probe end section 400 having the handle 126 connected thereto using, for example, a mechanical and electronic interface. The probe end section 400 may include various components, such as for example and without limitation, an internal shaft, a housing, bearings, electronics that may perform signal processing and/or other functions, light rings and a lock nut. The contacting or non-contacting measurement device 118 is mounted to the measurement probe housing 102. As described in more detail hereinafter, the measurement probe housing 102, the measurement device 118, and/or the handle 126 may also include mechanical, electronic and/or optical components that are integrated into the probe end housing 102, the measurement device 118, and/or the handle 126 and are part of the illumination lights or other similar illumination features of embodiments of the present invention.

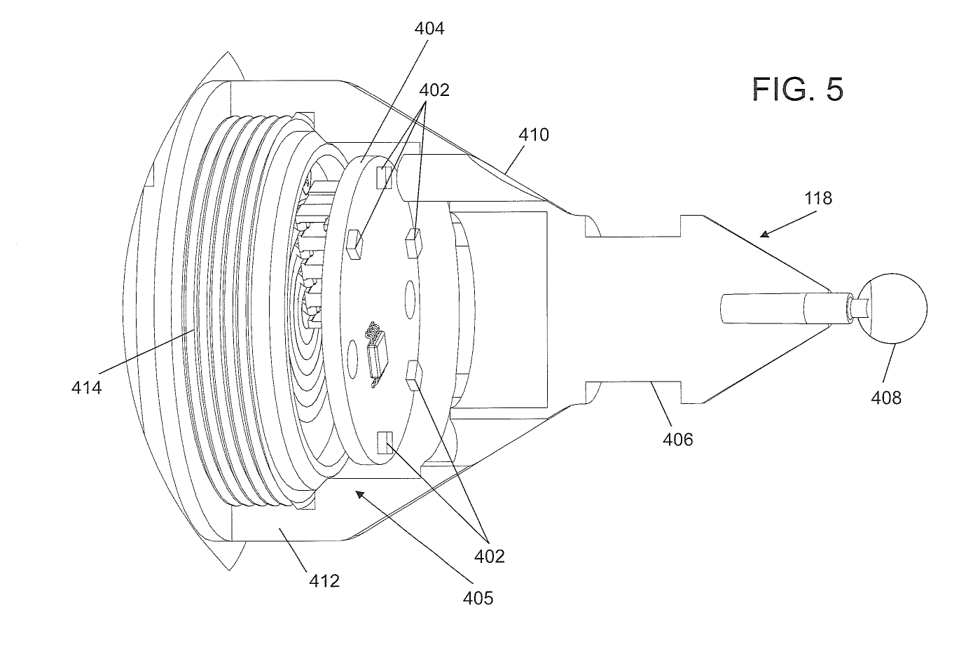

Referring to FIGS. 4-5, there illustrated is an embodiment of the present invention in which the measurement device 118 and the area adjacent the measurement device 118 are illuminated with one or more light sources such as, for example, light emitting diodes (LEDs) 402. In other embodiments, the light sources may be a projector such as a digital micromirror device (DMD) or a liquid crystal on silicon (LCOS) projector for example.

In this embodiment of an illuminated measurement device or “i-Probe,” a measurement device 118 includes an electronic interface circuit board 404 located at an interface 405 between the probe end section 401 and the measurement device 118. In one embodiment, the electronic interface circuit board 404 is disposed within a body 406 of the measurement device 118 and which contains the one or more light sources, such as LEDs 402. Examples of such embodiments include, without limitation, the LEDs 402 being mounted on the electronics interface board 404, where the board 404 is installed within the body 406 and is electronically connected to the probe end housing 102. The body 406 may include a threaded portion 412 that cooperates with a threaded member 414 on the end of the measurement probe housing 102 to couple the measurement device 118 to the measurement probe housing 102.

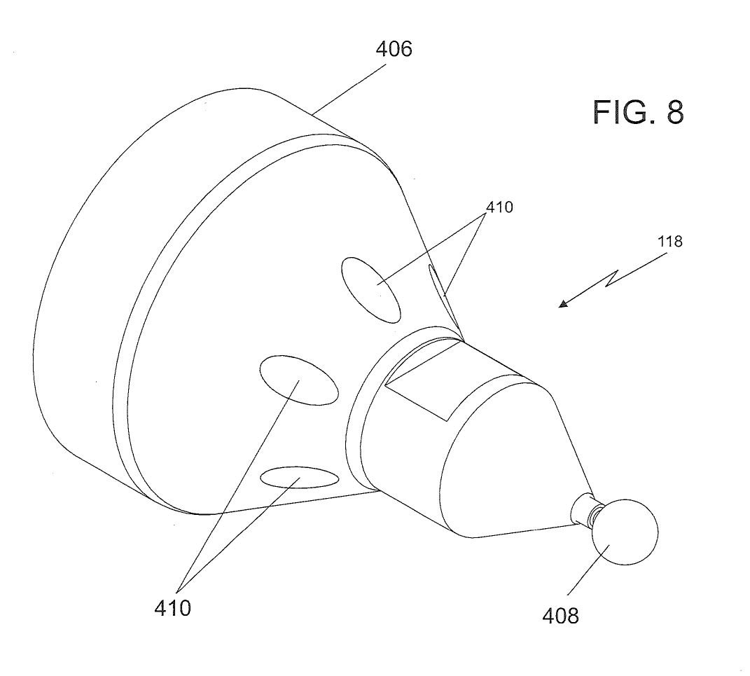

The LEDs 402 may be aligned to face the tip end 408 and provide illumination through the body 406 to a targeted area such as, for example, a portion of a part being measured by the AACMM 100. More specifically, one or more holes or lenses 410 (FIG. 8) in the cone shaped portion of the body 406 may allow light from the LEDs 402 to exit the measurement device 118 and may focus this light at the targeted area, thereby illuminating the work surface of the part near the tip end 408. In the exemplary embodiment, five LEDs 402 are disposed on the electronics interface board 404 and are aligned to direct light through a corresponding opening or lens 410. In another embodiment, a plurality of LEDs 402 are disposed equally about the electronics interface board 404 (e.g. four LEDs arranged 90 degrees apart). It should be appreciated that the location of the light source at the interface of the probe end section and measurement device or in the measurement device provides advantages in projecting light onto the work surface without interference from the operator's hand.

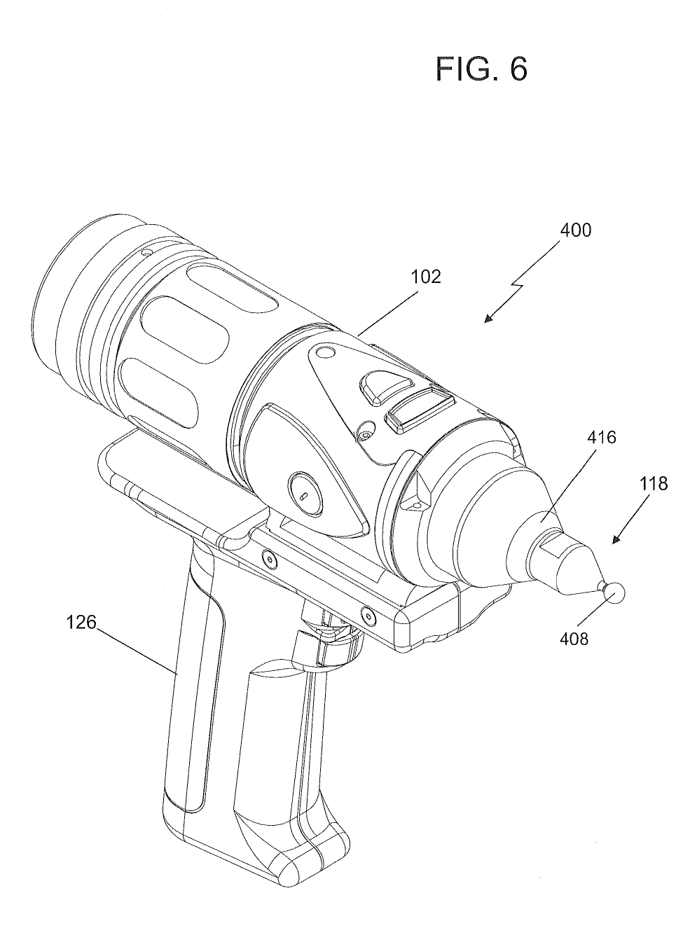

Referring to FIG. 6, there illustrated is an embodiment of the present invention in which a light pipe originating from one or more light sources (e.g., LEDs 402, a DMD or (LCOS) projector) within the body 406 is configured as a light ring 416. In one embodiment, the light ring 416 provides 360 degrees of illumination around the body 406 near the tip end 408. In another embodiment, the light ring 416 extends less than 360 degrees (e.g. 180 degrees). In yet another embodiment, a light ring 416 is provided that extends less than 360 degrees and is arranged to allow the operator to rotate the light ring 416 about the body 406.

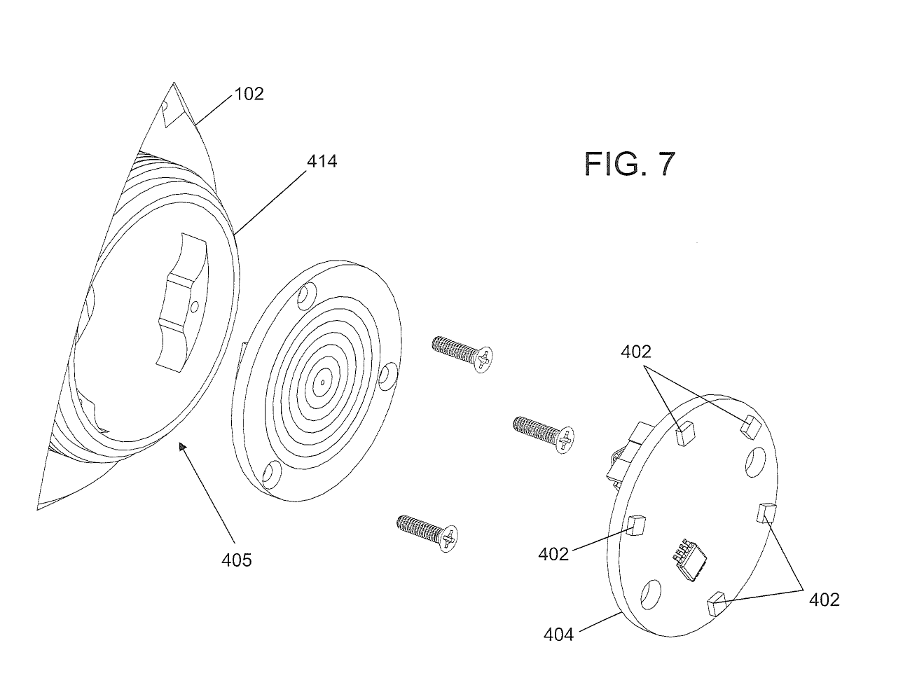

Referring to FIG. 7, there illustrated is an embodiment of the present invention in which the LEDs 402 and the one or more electronics circuit boards 404 are installed within the measurement probe housing 102 at the end of the AACMM 100, instead of in the body 406, as in the embodiment of FIG. 5. Referring also to FIG. 8, in this embodiment the light source(s) 402 direct their light to a targeted area through holes, light pipes or lenses 410 located in a body 406 that may contain none of the electronics circuit boards 404 and also may not provide accommodation for any electrical connections.

It should be appreciated that while embodiments herein may refer to the light source as being LEDs 402, this is for exemplary purposes and the claimed invention should not be so limited. The light source used to illuminate the work area may include but is not limited to: an incandescent lamp; an organic light emitting diode (OLED); a polymer light emitting diode; a gas discharge lamp; fluorescent lamp; a halogen lamp; a high-intensity discharge lamp; a metal halide lamp; a DMD projector or a liquid crystal LCOS projector for example.

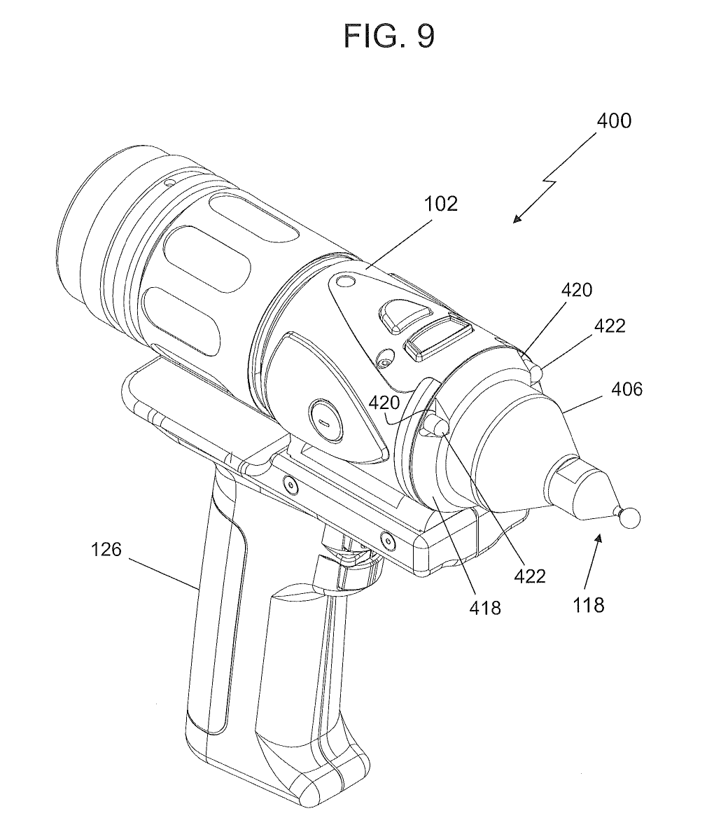

Referring to FIG. 9, there illustrated is another embodiment of the present invention in which the probe end section 400 of the AACMM 100 of FIG. 1 (to which the measurement device 118 is mounted) is illuminated by, for example, one or more light sources, such as LEDs 402 for example. In another embodiment, the LEDs 402 may be located on an electronic interface circuit board 404 that is located inside the measurement probe housing 102 of the AACMM 100. Holes, lenses or light pipes 410 located in the measurement probe housing 102 may be used to direct light forward toward the tip end 408, as well as around the tip end 408. Alternatively or in addition, a light pipe or light ring located on the circumference of the measurement device 118 can be used to provide general area illumination, similar to the embodiment of FIG. 6. In the embodiment of FIG. 9, the body 406 may have a conical surface 418 adjacent the threaded portion 412. The conical surface 418 includes at least one recess 420. Extending from the recess 420 is a lens 422 that cooperates with a feature similar to holes, lenses or light pipes 410 to emit light generated by the LEDs 402. In one embodiment, the LEDs 402 are disposed within the lens 422.

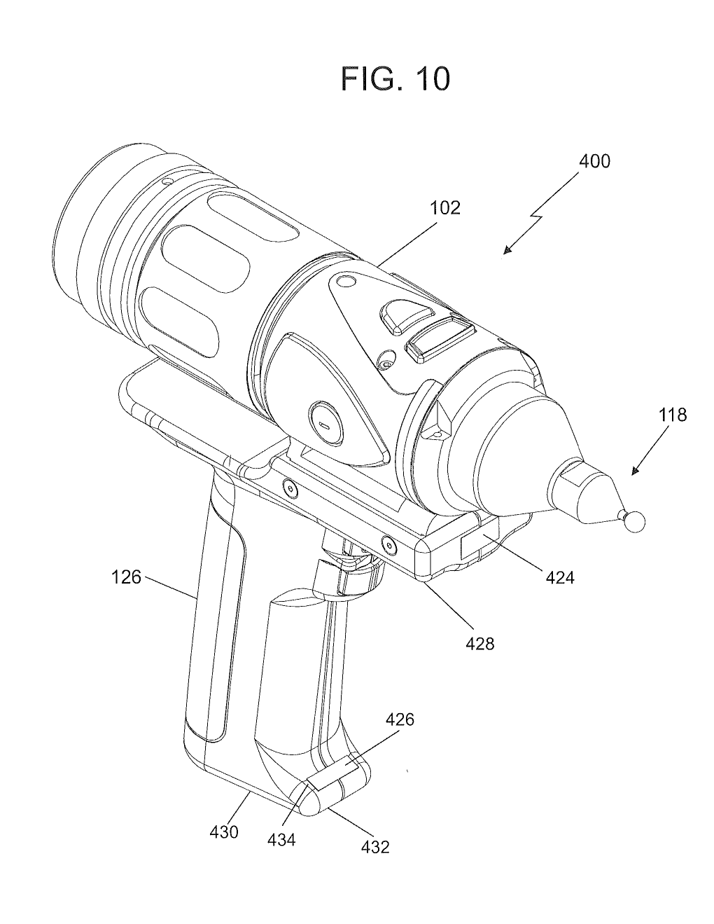

In still other embodiments of the present invention, accessories that attach to the probe end section 400 of the AACMM of FIG. 10 may be utilized primarily for illumination, or include illumination as a secondary benefit. For example, FIG. 10 illustrates a handle 126 attached to the measurement probe housing 102 of the AACMM 100. In this embodiment the handle 126 includes one or more integrated light sources 424, 426. The first light source 424 is disposed on a projection 428 on handle 126 adjacent the measurement device 118. The first light source 424 may include a lens member that focuses or diffuses the light being emitted from the first light source 424. The lens member may be configured to allow the operator to manually adjust the focus and diffusion of the light.

The handle 126 may include a second light source 426 disposed on an end 430 opposite the measurement probe housing 102. The end 430 may include a projection 432 having an angled surface 434. The second light source 426 may be disposed on the angled surface 434 to emit light on an angle towards the measurement device 118 and the surrounding area. It should be appreciated that the second light source 426 may provide advantages in distributing light on work surface to provide improved visibility in applications where a light source disposed near the measurement device 118 may be blocked from the desired viewing area. In one embodiment, the second light source 426 includes a lens. The lens may be manually adjustable to allow the operator change the location and amount of light directed towards the measurement device 118.

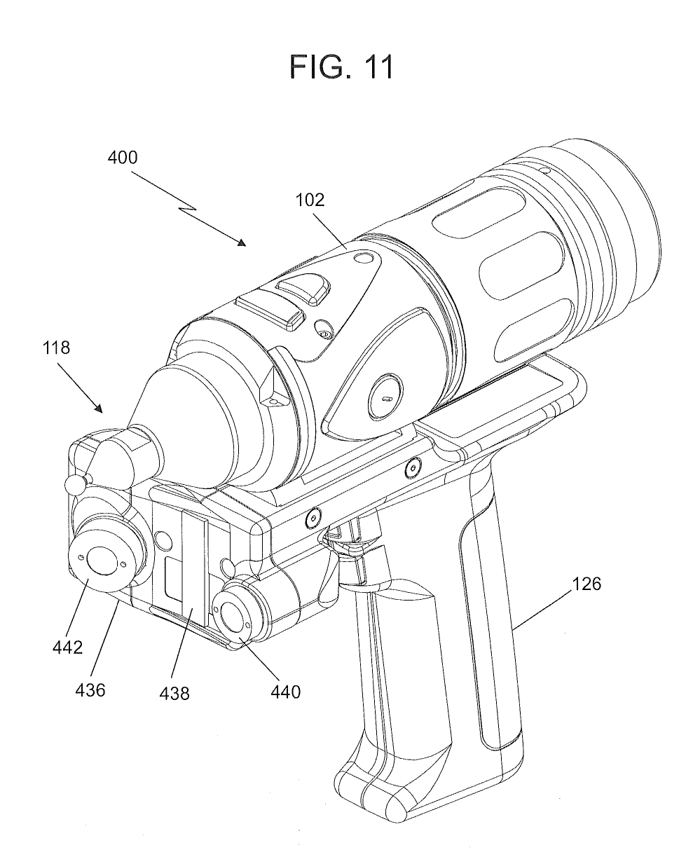

Referring to FIG. 11, there illustrated is a handle 126 having a laser line probe (LLP) 436 with a light source 438. An LLP 436 is an accessory for an AACMM 100 having an optical device 440, such as a laser for example, arranged adjacent a sensor 442, such as a camera for example. The LLP 436 allows for the acquisition of three-dimensional coordinate data without contacting the object. The LLP 436 may have a focal point or focal line where the coordinate data is optimally acquired. In this embodiment, the LLP 436 includes an integrated light source 438 disposed between the optical device 440 and the sensor 442. The light source 438 emits light in the area adjacent the measurement device 118 and the LLP 436, such as in the area of an optimal focal point/line. It should be appreciated that the probe end section 400 having an LLP 436 may also include additional light sources, such as LEDs 402 disposed in the measurement device 118 or measurement probe housing 102 that cooperate to provide a desired illumination of the work surface or object being measured.

Unlike the light emitted by the optical device 440, the light emitted by light source 438 is provided in such a way as to minimize the response from sensor 442. In an embodiment, this insensitivity is achieved by powering the light source 438 only when the LLP is not collecting data. In another embodiment, the insensitivity is achieved by minimizing the effect of the wavelength of light from light source 438 on the sensor 442, either by selecting a wavelength for light source 438 that substantially reduces or minimizes the response from the sensor 442 or by adding an optical filter over the sensor 442 to block the wavelengths from the light source 438.

In commercially available laser line probes, the light emitted by the optical device 440 is laser light, which is a type of light that has high coherence. The light source 438, on the other hand, which is intended for general illumination, has low coherence. In the future, light emitted from the optical device 440 may come from a super luminescent diode (SLD), which is another type of low coherence device.

Accessories other than an LLP 436 that may be mounted to the probe end section 400 of the AACMM 100 may each include one or more light sources of illumination in accordance with the teachings herein in exemplary embodiments of the present invention. These various accessories may include, for example and without limitation: (1) a camera with an integrated light source, which may include flash capability for photography; (2) a thermal imagery device with an integrated light source; (3) a bar code reader with an integrated light source; (4) a non-contact temperature sensor with an integrated light source; (5) a projector with or used as a light source; and (6) a stand-alone light source, for example, as a mountable accessory.

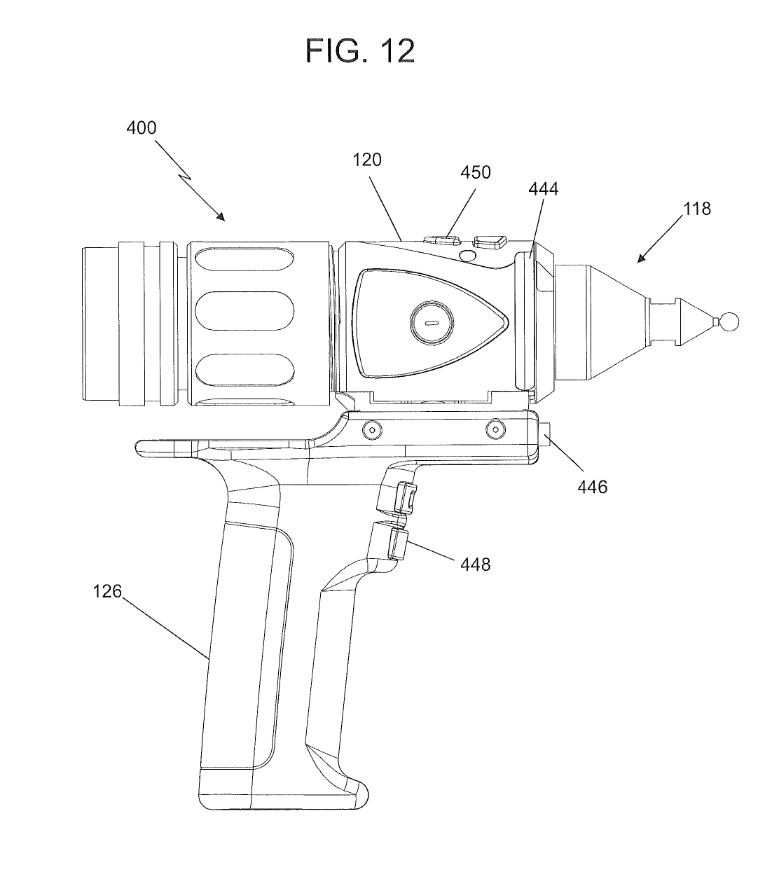

In other embodiments of the present invention, dual function lighting allows for the possibility to have multi-purpose light sources. Such dual function lighting arises, for example, from the advent of multi-color (e.g., RGB) LED components that can be controlled to produce any color or a continuous spectrum of light (as interpreted by the human eye). Generally, we refer to light sources that can produce more than one color of light as variable-spectrum light sources. For example, a variable-spectrum light source may contain red, blue, and green lights that can be illuminated one at a time or combined to produce nearly any color in the visible spectrum, as perceived by the human eye. Referring to FIG. 12, LEDs or other light sources or indicators, such as a light ring 444 for example may be used to indicate status of the AACMM 100. For example, a blue light (450-475 nanometers) may be emitted for “Power On”, red (620-750 nanometers) for “Stop”, amber for “Warning”, or green (495-570 nanometers) for “Good”, etc., all of which may be commanded or changed to a white light for general illumination purposes. In FIG. 12, these status lights may be in the form of a single 360-degree light ring 444 located on the measurement probe housing 102 or handle 126 of the AACMM 100 of FIG. 1. Also, the light ring 444 may be used to provide general illumination, instead of a status indicator, when commanded to produce white light. The light ring may further be used to communicate to the operator the type of measurement to be performed next. For example, if a diameter is the next measurement, the ring may be illuminated all the way around. If the next measurement is above the current location, the top portion of the light ring may be illuminated.

Referring again to FIGS. 4-5, LEDs 402 located on the measurement device 118 (or the probe end portion 400) and intended for general illumination can also be commanded to change their color of illumination to indicate a status of the AACMM 100. In this way, the status light color can be projected onto the part surface targeted area, thereby providing feedback to the operator without having to look at an indicator light on the AACMM 100. For example, the color of lights used for general illumination may be changed for a specific application. As examples, blue light, instead of white light, may be used with an LLP 436 to provide surface illumination without the possibility of interfering with the wavelength (e.g., red) of the light source in the LLP. In addition, red light might be used in low light situations, or situations where it is desirable to minimize glare and reduce the range over which the light is seen. When illuminating colored surfaces, a light color can be chosen to maximize contrast. When used in conjunction with other devices that might project grids, targets or other visual cues onto the part surface, a color can be chosen that does not visually obliterate that image or interfere with the operation of the device producing and utilizing the image.

In one embodiment, the light source such as light ring 444 includes a continuous spectrum light source, such as an RGB LED 402 for example, that is operably coupled with a sensor 446. The sensor 446 may be a range finder or a pyrometer for example. The sensor 446 measures a desired parameter and provides a signal to a controller (not shown) disposed within the measurement probe housing 102. The controller changes the color, or a shade of the color emitted by the light ring 444 in response to the measured parameter either passing a threshold (e.g., a temperature threshold or a distance threshold) or being within a desired range. Where the sensor 446 is a range finder, the shade of the emitted color may be changed as the probe end portion 400 moves closer to the object. This provides advantages in allowing the operator to receive a visual indication as to the distance to the object, even if the tip end 408 of measurement device 118 is not visible to the operator (e.g. within a cavity). In an embodiment with an LLP 436, the color or shade may change when the object is within a desired range of the LLP focal point/line. In one embodiment, the light ring 444 may change to a shade or a different color when the measurement probe is in a desired location for obtaining a particular measurement, such as the diameter of a cylindrical hole half way between the bottom and the surface of the hole for example.

In other embodiments, the sensor 446 may be a temperature measurement device such as a pyrometer for example. In this embodiment, the color or shade of the light ring 444 may be changed in response to the temperature of the object or the surrounding environment. This arrangement provides advantages by giving the operator with a visual feedback on whether it is desirable to position the probe end portion 400 in the area where the measurement is to be taken. If the temperature is too high, the acquired measurement may be erroneous (due to thermal expansion) or the measurement device may be damaged due to the high temperatures.

The light sources described herein may be activated by the operator such as through the actuation of button 448 on the handle 126 or button 450 on the probe housing 102. The light sources may further be activated by a command issued from the electronic data processing system 210, the user interface board 202 or via a remote computer. This provides advantages in allowing the light source to be turned on by a second operator in the event the operator manipulating the probe end portion 400 is in a confined space or is otherwise unable to depress one of the buttons 448, 450.

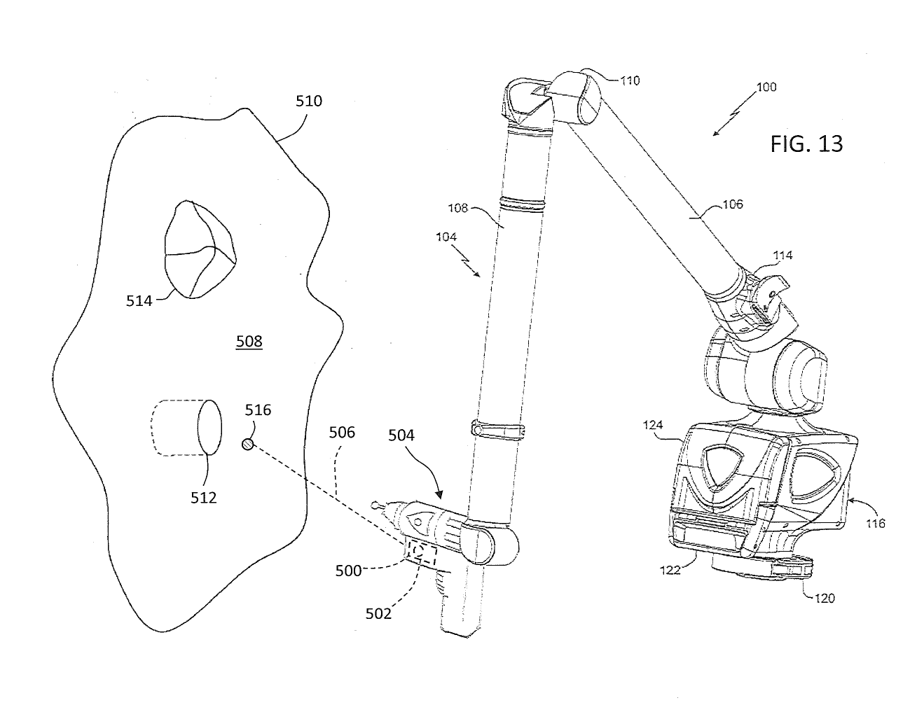

Referring now to FIGS. 13-18 another embodiment is shown having a light projector 500 having a at least one light source 502 arranged in the probe end section 504. The light projector 500 is configured to direct a visible light 506 onto the surface 508 of an object 510 that the operator desires to measure. The light source 502 may be a digital light projector (DLP), a digital micromirror device or a liquid crystal on silicone type of device for example. The object 510 may have a number of features, such as an opening or hole 512 or a contoured surface 514 for example. The light 506 forms a indicator 516 on the surface 508, the indicator 516 may be a light pattern formed by spot of light, a line, a geometric shape or may be a pattern that forms a user recognizable symbol for example. In one embodiment, the shapes, patterns or symbols are formed by a swept spot of light.

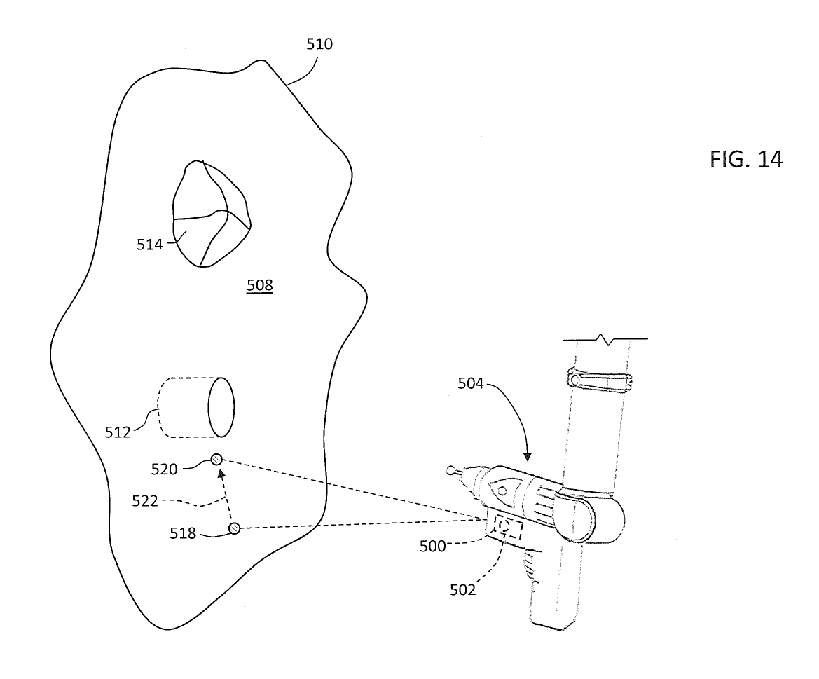

The indicator 516 may be used to convey information to the operator. In the exemplary embodiment, the light projector 500 is configured to move the light from a first position 518 to a second position 520 along a path 522 (FIG. 14). This movement may indicate to the operator the direction of the next measurement to be taken for example. In one embodiment, the position of the indicator 516 is independent of the movement of the articulated arm portion 104 or the probe end section 504 such that the indicator 516 may remain in the same position while the arm portion 104 or probe end section 504 is moved in operation. It should be appreciated that the light projector 500 is in bi-directional communication with the electronic data processing system 210 to allow the tracking of the movement of the arm portion 104 and allow for the adjustment of the vector of the light 506 to maintain the indicator 516 in the same location.

In the exemplary embodiment, the electronic data processing system 210 includes data and information on the measurements to be performed by the AACMM 100. This data may include an inspection plan for the object 510 for example. In operation, the electronic data processing system 210 determines the next measurement to be acquired. The indicator 516 may be moved to communicate to the operator the location and/or the type of measurement to be performed using the indicator 516. The light projector 500 may be configured to move the indicator along a linear path, a circular path, a curved path for example. The light projector 500 may be further configured to change the color of the indicator 516, to modulate the indicator 516, to change the shape of the indicator 516 or a combination of the foregoing. Where the indicator 516 has a temporal characteristic, the indicator 516 may change brightness, speed or color as a function of time for example.

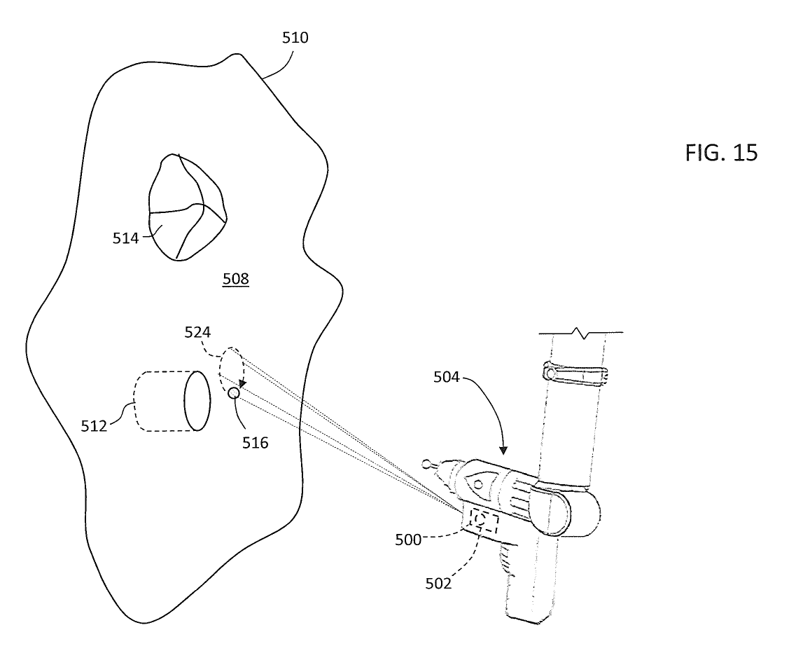

Communication with the operator via the indicator 516 may be accomplished by the movement of the indicator 516. For example, in FIG. 14, the indicator is moved along a linear path 522. This may indicate that the next measurement to be acquired may be found in the direction of movement of the indicator 516. In the case of a measurement that involves multiple data points, such the flatness of the surface 508 for example, the path 522 may indicate the next direction or area where the measurement device should move to acquire additional data. In the embodiment shown in FIG. 15, the path may be in the form of a pattern, such as a circular path 524. This may indicate to the operator that they should next measure the diameter of the hole 512 for example. It should be appreciated that the path 524 may form a number of light patterns, such as a square, a triangle, a hexagon, a figure-eight or a star for example, each representing a different type of measurement. Still further information may be communicated to the operator by modulating or changing the color, such as changing the color of the indicator to red as the measurement device 118 approaches the feature(s) to be measured. In some instances, the location of the measurement may be inside of an opening, such as hole 512 for example. In this instance, the color may change when the measurement device 118 is located at the desired depth.

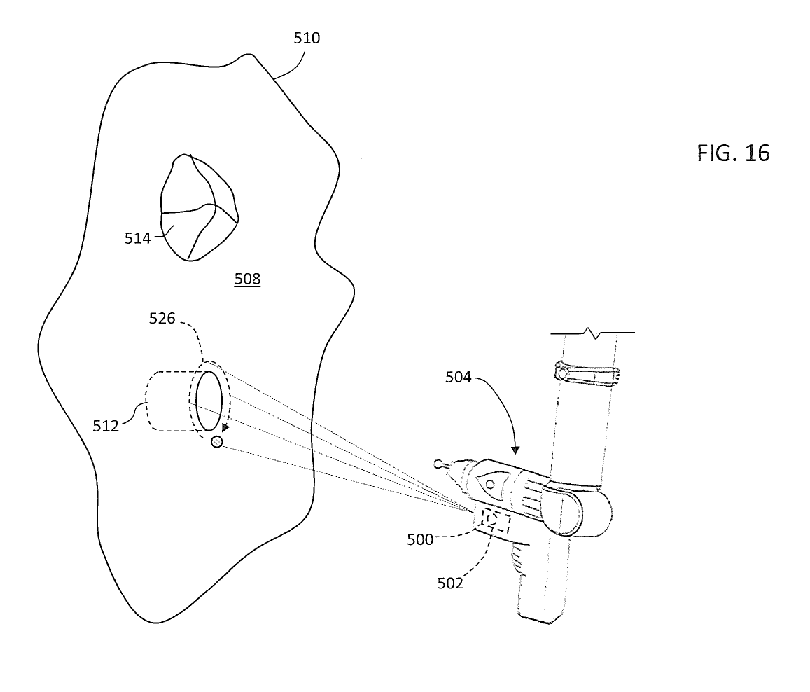

In another embodiment such as that shown in FIG. 16, the path 526 may form a light pattern that outlines or circumscribes the feature to be measured. This provides advantages in assisting the operator identify the correct feature to measure. It provides still further advantages in the measurement of irregular shapes for which a standard indicating pattern may not be available or on objects 510 having many similar features (e.g. a plurality of holes next to each other).

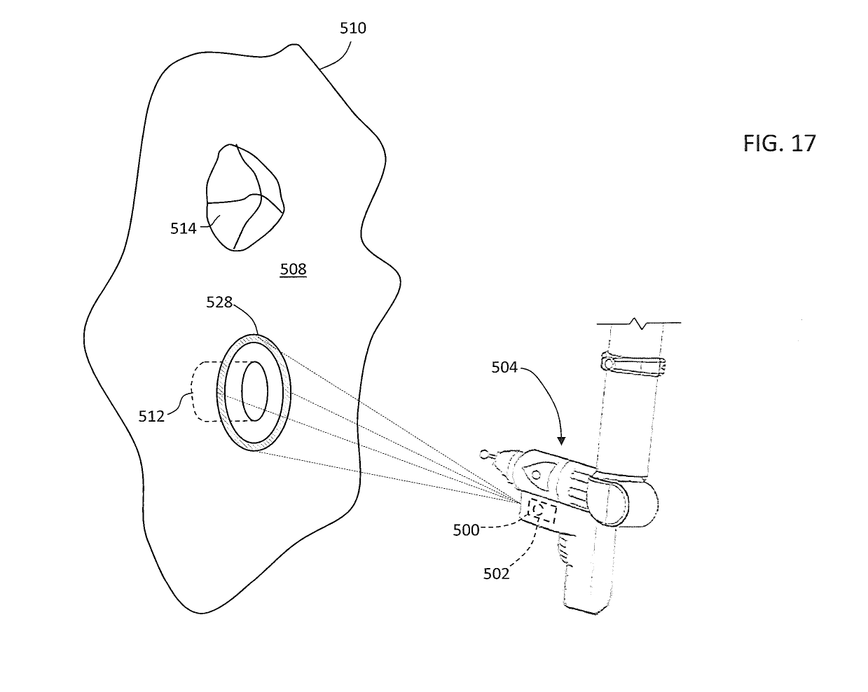

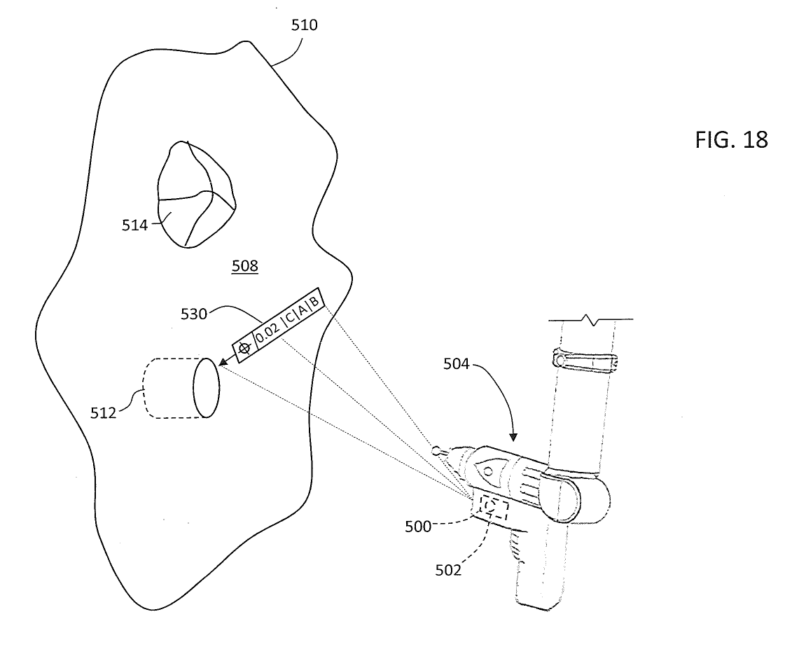

In some embodiments described herein, the indicator 516 is a spot of light (a small circular area of light) that is held stationary or swept along a path. However, this is for exemplary purposes and the claimed invention should not be so limited. In other embodiments, such as that shown in FIG. 17, the indicator 528 may form a light pattern of a shape, such as a contiguous circle formed around hole 512 for example. It should be appreciated that the shape of the indicator is not limited to circular shapes, but may take the form of more complex shapes, or may include words or symbols. In some embodiments, such as that shown in FIG. 18, the indicator 530 may form a dimension. In one embodiment, the indicator 530 forms a light pattern in the shape of a symbol compliant with the Geometric Dimensioning and Tolerancing (GD&T) standards, such as ASME Y14.5-2009, ISO 128, ISO 7083, ISO 13715 and ISO 15786 for example.

In another embodiment, the probe end section 504 includes a measurement device such as a laser line probe (FIG. 11). In these embodiments, the indicator 516 may communicate with the operator information about the quality of the data being acquired by the laser line probe. For example, if the laser line probe is being moved at a speed higher than a threshold, then the density of collected points may be lower than desired. The indicator 516 may then be used to communicate to the operator to slow down the scan, such as by changing the color of the indicator 516 for example. Further, the indicator 516 may be used to communicate with the operator if the orientation of the laser line probe is reducing the quality of the scan. In one embodiment, the electronic data processing system monitors the data acquired by the laser line probe and indicates (e.g. changes the color of the indicator 516) if multipath interference is detected. The operator may then change the position and orientation of the laser line probe to remove the multipath interference.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of conveying information with a portable articulated arm coordinate measuring machine (AACMM), with steps comprising:
providing a manually positionable articulated arm portion having opposed first and second ends, the arm portion including a plurality of connected arm segments, each of the arm segments including at least one position transducer for producing position signals;
providing a measurement device coupled to the first end;
providing an electronic circuit for receiving the position signals from the transducers and for determining a first position of the measurement device;
providing a light source coupled to the first end, the light source configured to emit a light pattern on a surface of an object, the light pattern being a pattern of visible light;
providing a first processor;
determining with the first processor a location of a next measurement and a type of the next measurement to be performed by an operator, the type of the next measurement selected from among a plurality of measurement types;
determining with the first processor the light pattern based at least in part on the type of the next measurement; and
projecting the light pattern proximal to the location.

2. The method of claim 1, wherein the determining with the first processor the location and the type of the next measurement is further based at least in part on a change in the light pattern over time.

3. The method of claim 2 further comprising forming the light pattern with a swept spot of light.

4. The method of claim 1 wherein the providing of the light source includes providing a digital micromirror device (DMD) or a liquid crystal on silicon (LCOS) projector.

5. The method of claim 1 wherein determining with the first processor the light pattern includes determining a geometric dimensioning and tolerancing (GD&T) symbol associated with the next measurement.

6. The method of claim 5 wherein projecting the light pattern proximal to the location further includes projecting the geometric dimensioning and tolerancing symbol.

7. The method of claim 6 further comprising measuring three-dimensional coordinates of at least one point on the surface of the object based at least in part on data provided by the electronic circuit.

8. The method of claim 7 further comprising changing a color of a portion of the geometric dimensioning and tolerancing (GD&T) symbol based at least in part on the measured three-dimensional coordinates.

9. The method of claim 1 wherein in the projecting of the light pattern, the light pattern encloses a feature to be measured.

10. The method of claim 2 wherein the projecting of the light pattern further includes circumscribing a feature to be measured by changing the light pattern.

11. The method of claim 2 wherein the projecting of the light pattern further includes changing a color of at least a portion of the light pattern.

12. The method of claim 2 wherein the projecting of the light pattern further includes changing a color of the light pattern in response to a measured position of the measurement device.

13. The method of claim 12 wherein the measured position is at a reference depth in relation to the surface of the object in a region of the surface surrounding an opening in the surface.

14. The method of claim 1 wherein the projecting the light pattern further includes setting a color of the light pattern based at least in part on a speed of the measurement device.

15. The method of claim 1 wherein in the step of providing of the measurement device the measurement device is a laser line probe and in the projecting of the light pattern a color of the light pattern is based at least in part on a density of collected points.

16. The method of claim 1 wherein in the providing of providing the measurement device the measurement device is a laser line probe and in the projecting of the light pattern a color of the light pattern is based at least in part on an orientation of the laser line probe.

17. The method of claim 1 further comprising detecting multipath interference and setting a color of a portion of the light pattern in response to detecting multipath interference.

18. The method of claim 1 wherein the projecting of the light pattern further includes modulating the light pattern in response to a second position of the light pattern in relation to the location of the next measurement.

19. The method of claim 18 wherein the modulating of the light pattern further includes modulating a color of the light pattern.

20. The method of claim 18 wherein the modulating of the light pattern further includes modulating a brightness of the light pattern.

21. The method of claim 1 wherein the projecting of the light pattern includes projecting a symbol onto the surface of the object.

22. A portable articulated arm coordinate measuring machine (AACMM), comprising:
a manually positionable articulated arm portion having opposed first and second ends, the arm portion including a plurality of connected arm segments, each of the arm segments including at least one position transducer for producing position signals;
a measurement device coupled to the first end;
an electronic circuit for receiving the position signals from the transducers and for determining a position of the measurement device;
a light source coupled to the first end, the light source configured to emit a light pattern on a surface of an object, the light pattern being a pattern of visible light; and
a first processor configured to perform steps of:
determining with the first processor a location of a next measurement and a type of the next measurement to be performed by an operator, the type of the next measurement selected from among a plurality of measurement types;
determining with the first processor the light pattern based at least in part on the type of the next measurement; and
projecting the light pattern proximal to the location.

23. The portable articulated arm coordinate measuring machine of claim 1, further comprising a digital micromirror device (DMD) or a liquid crystal on silicon (LCOS) projector.

24. The portable articulated arm coordinate measuring machine of claim 1, wherein the light source is further configured to emit light having a plurality of colors.

25. The portable articulated arm coordinate measuring machine of claim 1, wherein the measurement device is a laser line probe.

26. The portable articulated arm coordinate measuring machine of claim 1, wherein the light source is further configured to modulate the light pattern.
